(19) United States
(12) Patent Application Publication
(10) Pub. No.: US 2015/0178801 A1
(43) Pub. Date: Jun. 25, 2015

(54) SALES MANAGEMENT SUPPORT SYSTEM

(71) Applicant: Seiko Epson Corporation, Tokyo (JP)

(72) Inventors: Hideki OKADA, Shiojiri (JP); Shinya MOMOSE, Matsumoto (JP); Daisuke MATSUMOTO, Matsumoto (JP); Akio ITO, Matsumoto (JP)

(73) Assignee: Seiko Epson Corporation, Tokyo (JP)

(21) Appl. No.: 14/290,321

(22) Filed: May 29, 2014

(30) Foreign Application Priority Data
Dec. 19, 2013 (JP) 2013-262654

(51) Int. Cl. G06Q 30/06; G06Q 50/26

(52) U.S. Cl. CPC G06Q 30/0601; G06Q 50/265

(57) ABSTRACT

A sales management support system includes a first server, and a second server that is connected to the first server through a network, and installed in a store. When selling a drug/food to a customer, the second server compares contraindication-related ingredient information corresponding to the drug/food that is sold to the customer with the contraindication-related ingredient information corresponding to the drug/food purchased by the customer in another store based on the contraindication-related ingredient information stored in a second server-side storage section, and purchase history information transmitted from the first server in response to request information, and generates contraindication information corresponding to the comparison result, the contraindication information indicating contraindications to the drug/food combination, or precautions against the drug/food combination.

Japanese Patent Application No. 2013-262654 filed on Dec. 19, 2013 is hereby incorporated by reference in its entirety.

### BACKGROUND OF THE INVENTION

The present invention relates to a sales management support system that supports drug/food sales management.

A drug history management system has been known that is configured to store personal drug information about each patient and dosing instruction information about each drug, and search (display) the dosing instruction information about the prescribed drug from the personal drug information about a particular patient in order to determine whether the patient can take the prescribed drug without a problem (see JP-A-2001-273366, for example).

However, a known drug history management system is not designed so that the user can check whether or not it is appropriate to take a drug/food purchased in different stores in combination.

### SUMMARY

Several aspects of the invention may provide a sales management support system that can present contraindication information (i.e., information that indicates contraindications to a particular drug/food combination, or precautions against a particular drug/food combination) even when the user purchases a drug/food in different stores.

According to one aspect of the invention, there is provided a sales management support system that supports drug/food sales management, and includes a first server, and a second server that is connected to the first server through a network, and installed in a store, the first server including:
a first server-side storage section that stores a contraindication-related ingredient information table and a purchase history information table, the contraindication-related ingredient information table storing contraindication-related ingredient information about a contraindication-related ingredient included in a drug/food that is on sale in the store, and the purchase history information table storing purchase history information about a drug/food that was purchased by a customer; and
a first server-side communication processing section that performs a process that transmits first contraindication-related ingredient information stored in the contraindication-related ingredient information table or first purchase history information stored in the purchase history information table to the second server, and a process that receives second purchase history information about a drug/food that was purchased by the customer in the store, or second contraindication-related ingredient information based on the purchase history information from the second server, and stores the received second purchase history information or the received second contraindication-related ingredient information in the history information table or the contraindication-related ingredient information table,
the first server-side communication processing section performing a process that transmits the first purchase history information or the first contraindication-related ingredient information to the second server in response to request information received from the second server, and
the second server including a contraindication information generation section that generates contraindication information based on the first purchase history information or the first contraindication-related ingredient information transmitted from the first server when selling a drug/food to the customer, the contraindication information indicating contraindications to intake of a drug/food combination, or precautions against intake of the drug/food combination.

### BRIEF DESCRIPTION OF THE SEVERAL VIEWS OF THE DRAWING

FIG. 1 is a diagram illustrating an example of the configuration of a sales management support system according to one embodiment of the invention.

FIG. 2 is a functional block diagram illustrating the configuration of a central server (first server) according to one embodiment of the invention.

FIG. 3 is a functional block diagram illustrating the configuration of a store server (second server) according to one embodiment of the invention.

FIG. 4 is a functional block diagram illustrating the configuration of a terminal (information processing terminal) according to one embodiment of the invention.

FIG. 5 illustrates an example of a contraindication-related ingredient information table.

FIG. 6 illustrates an example of a purchase history information table.

FIG. 7 illustrates a contraindication information generation process.

FIG. 8 illustrates a contraindication information generation process.

FIG. 9 illustrates an example of a web page that displays a shopping cart.

FIG. 10 is a flowchart illustrating the flow of a process performed by a central server (first server).

FIG. 11 is a flowchart illustrating the flow of a process performed by a store server (second server) installed to provide an online shopping site.

FIG. 12 is a flowchart illustrating the flow of a process performed by a store server (second server) installed in an actual store.

FIG. 13 is a diagram illustrating a modification.

### DETAILED DESCRIPTION OF THE EMBODIMENT

(1) According to one embodiment of the invention, a sales management support system supports drug/food sales management, and includes a first server, and a second server that is connected to the first server through a network, and installed in a store, the first server including:
a first server-side storage section that stores a contraindication-related ingredient information table and a purchase history information table, the contraindication-related ingredient information table storing contraindication-related ingredient information about a contraindication-related ingredient included in a drug/food that is on sale in the store, and the purchase history information table storing purchase history information about a drug/food that was purchased by a customer; and
a first server-side communication processing section that performs a process that transmits first contraindication-related ingredient information stored in the contraindication-related ingredient information table or first purchase history information stored in the purchase history information table to the second server, and a process that receives second purchase history information about a drug/food that was purchased by the customer in the store, or second contraindication-related ingredient information based on the purchase history information from the second server, and stores the received second purchase history information or the received second contraindication-related ingredient information in the history information table or the contraindication-related ingredient information table,
the first server-side communication processing section performing a process that transmits the first purchase history information or the first contraindication-related ingredient information to the second server in response to request information received from the second server, and
the second server including a contraindication information generation section that generates contraindication information based on the first purchase history information or the first contraindication-related ingredient information transmitted from the first server when selling a drug/food to the customer, the contraindication information indicating contraindications to intake of a drug/food combination, or precautions against intake of the drug/food combination.

Since the sales management support system is configured so that the second server generates the contraindication information that indicates contraindications to (or precautions against) intake of a drug/food combination based on the first purchase history information or the first contraindication-related ingredient information transmitted from the first server when selling a drug/food to the customer, it is possible to present the contraindication information even when the user purchases a drug/food in different stores.

(2) In the sales management support system, the first contraindication-related ingredient information or the first purchase history information may include the purchase history information or the contraindication-related ingredient information about a drug/food that was purchased by the customer in a store other than the store in which the second server is installed.

This configuration makes it possible to present the contraindication information even when the user purchases a drug/food in different stores.

(3) In the sales management support system, the second server may further include a second server-side storage section that stores the first contraindication-related ingredient information or the first purchase history information received from the first server.

This configuration makes it possible to reduce the amount of data exchanged between the second server and the first server.

(4) In the sales management support system, the contraindication information generation section may compare the first contraindication-related ingredient information corresponding to a drug/food that is sold to the customer with the contraindication-related ingredient information corresponding to a drug/food that was purchased by the customer in another store, and generate the contraindication information corresponding to a comparison result.

This configuration makes it possible to present the contraindication information even when the user purchases a drug/food in different stores.

(5) In the sales management support system, the first server-side communication processing section may not transmit the first purchase history information to the second server in response to the request information received from the second server when the first contraindication-related ingredient information does not fall under the request information.

This configuration makes it possible to reduce the amount of data exchanged between the second server and the first server. It is also possible to protect the privacy of information.

(6) In the sales management support system, the contraindication information generation section may perform a comparison process on the contraindication-related ingredient information corresponding to a drug/food that is sold to the customer based on the first contraindication-related ingredient information or the first purchase history information stored in the second server-side storage section, and generate the contraindication information.

This configuration makes it possible to reduce the amount of data exchanged between the second server and the first server.

(7) In the sales management support system, the first server may be connected to a plurality of the second servers respectively installed in a plurality of stores through an identical network or different networks.

(8) In the sales management support system, the first server may compare the first contraindication-related ingredient information with the second contraindication-related ingredient information, or comparing the first purchase history information with the second purchase history information, and update the contraindication-related ingredient information table and the purchase history information table.

(9) In the sales management support system, the contraindication-related ingredient information may be image information that includes pattern information that indicates a type and/or an amount of contraindication-related ingredient included in a drug/food that is on sale, and color information that indicates contraindications to, or precautions against, combined intake.

This configuration makes it possible for the user to easily visually determine the contraindication information.

(10) In the sales management support system, the contraindication information generation section may generate the contraindication information by performing image processing that synthesizes a plurality of pieces of the contraindication-related ingredient information.

This configuration makes it possible to easily generate the contraindication information from a plurality of pieces of contraindication-related ingredient information.

(11) In the sales management support system, the second server may further include a display control section that performs a control process that causes a display section to display the contraindication information.

(12) In the sales management support system, the second server may further include a print control section that performs a control process that causes a print section to print the contraindication information.

(13) The sales management support system may further include an information processing terminal that is connected to the first server through a network, the information processing terminal may include an information readout section that reads the contraindication-related ingredient information corresponding to a drug/food from a code provided to the drug/food, and an information processing terminal-side communication processing section that performs a process that transmits the contraindication-related ingredient information read by the information readout section to the first server together with personal information, the first server may further include a contraindication information generation section that compares the contraindication-related ingredient information received from the information processing terminal with the contraindication-related ingredient information corresponding to a drug/food that was purchased by a customer specified by the personal information received from the information processing terminal, and generate the contraindication information corresponding to a comparison result, the contraindication information indicating contraindications to intake of a drug/food combination, or precautions against intake of the drug/food combination, and the first server-side communication processing section may transmit the generated contraindication information to the information processing terminal.

This configuration makes it possible for the user to easily acquire the contraindication information by merely reading the code provided to the food/drug using the information processing terminal.

Exemplary embodiments of the invention are described in detail below with reference to the drawings. Note that the following exemplary embodiments do not unduly limit the scope of the invention as stated in the claims. Note also that all of the elements described in connection with the following exemplary embodiments should not be necessarily taken as essential elements of the invention.

### 1. Configuration

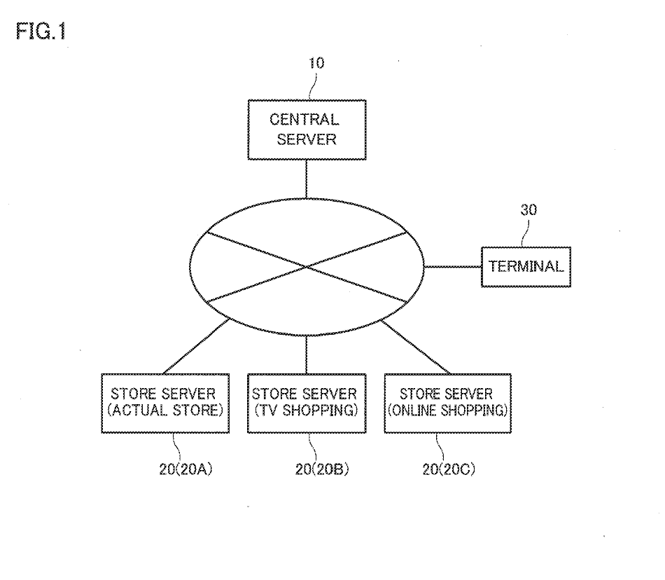

FIG. 1 illustrates a sales management support system according to one embodiment of the invention. As illustrated in FIG. 1, the sales management support system includes a central server 10, a plurality of store servers 20, and a terminal 30. The central server 10, the store servers 20, and the terminal 30 are configured to be able to connect to a network (Internet).

The central server 10 (first server) is connected to the store servers 20 and the terminal 30 through a network. The central server 10 exchanges information (e.g., contraindication-related ingredient information, purchase history information, and contraindication information) with the store servers 20 and the terminal 30. The central server 10 may be connected to the store servers 20 through an identical network, or may be connected to the store servers 20 through different networks.

Each store server 20 (second server) is a server that is installed in a drugstore or a grocery store. FIG. 1 illustrates an example in which a store server 20A is installed in an actual store (e.g., drugstore), a store server 20B is installed in a TV shopping business office, and a store server 20C is installed to provide an online shopping site.

The terminal 30 (information processing terminal) is a terminal that is possessed by an individual user. The terminal 30 is an information processing device such as a smartphone, a mobile phone, or a personal computer (PC).

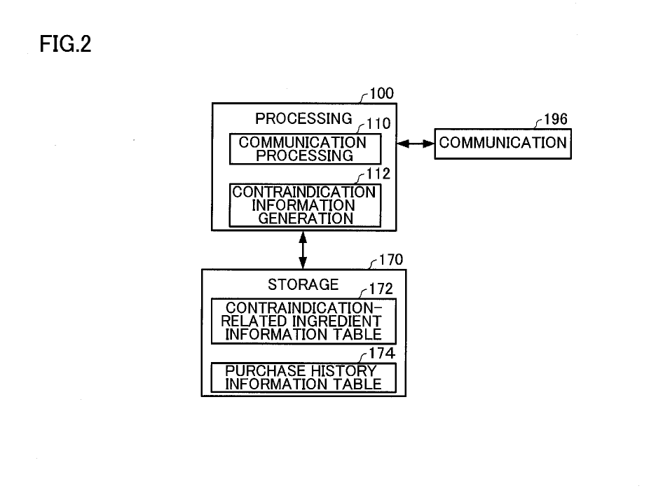

FIG. 2 illustrates an example of a functional block diagram of the central server 10. Note that the central server 10 may have a configuration in which some of the elements (sections) illustrated in FIG. 2 are omitted. The central server 10 includes a processing section 100, a storage section 170, and a communication section 196.

The storage section 170 (first server-side storage section) stores a program that causes a computer to function as each section of the processing section 100, and various types of data, and serves as a work area for the processing section 100. The function of the storage section 170 may be implemented by a hard disk, a RAM, or the like. The storage section 170 functions as a database that stores a contraindication-related ingredient information table 172 and a purchase history information table 174.

The contraindication-related ingredient information table 172 stores contraindication-related ingredient information about a contraindication-related ingredient that is included in a drug/food that is on sale in each store in which the store server 20 is installed. The purchase history information table 174 stores purchase history information about the drug/food purchased by each customer in each store. The purchase history information table 174 also stores information (e.g., ID information, insurance number, and pension number) that specifies each customer, information about the address, the age, the sex, the height, the weight, and the like of each customer, and information about a previous disease, a family history, a drug being taken, diathesis (allergic diathesis), and the like as personal information about each customer.

The communication section 196 performs a control process for communicating with the store server 20 and the terminal 30. The function of the communication section 196 may be implemented by hardware such as a processor or a communication ASIC, a program, or the like.

The processing section 100 (processor) performs various processes based on a program, data received through the communication section 196, and the like. The function of the processing section 100 may be implemented by hardware such as a processor (e.g., CPU or DSP), or a program. The processing section 100 includes a communication processing section 110 and a contraindication information generation section 112.

The communication processing section 110 (first server-side communication processing section) performs a process that transmits the contraindication-related ingredient information (first contraindication-related ingredient information) stored in the contraindication-related ingredient information table 172 or the purchase history information (first purchase history information) stored in the purchase history information table 174 to the store server 20 installed in each store, and a process that receives purchase history information (second purchase history information) about the drug/food purchased by each customer in each store from the store server 20 installed in each store, and stores the received purchase history information in the history information table 174. The communication processing section 110 may receive contraindication-related ingredient information (second contraindication-related ingredient information) based on the purchase history information about the drug/food purchased by each customer in each store from the store server 20, and store the received contraindication-related ingredient information in the contraindication-related ingredient information table 172. The processing section 100 compares the contraindication-related ingredient information stored in the contraindication-related ingredient information table 172 with the contraindication-related ingredient information received from the store server 20 to update the contraindication-related ingredient information table 172, and compares the purchase history information stored in the purchase history information table 174 with the purchase history information received from the store server 20 to update the purchase history information table 174.

The communication processing section 110 transmits the first contraindication-related ingredient information or the first purchase history information to the store server 20 in response to request information received from the store server 20. Specifically, the communication processing section 110 transmits the first contraindication-related ingredient information when the received request information requests the contraindication-related ingredient information, and transmits the first purchase history information when the received request information requests the purchase history information. Note that the purchase history information about the drug/food purchased by each customer in a store other than the store in which the store server 20 that has transmitted the request information is installed may be transmitted to the store server 20 that has transmitted the request information as the first purchase history information, and the contraindication-related ingredient information (i.e., the contraindication-related ingredient information based on the purchase history information) about the contraindication-related ingredient included in the drug/food purchased by each customer in a store other than the store in which the store server 20 that has transmitted the request information is installed may be transmitted to the store server 20 that has transmitted the request information as the first contraindication-related ingredient information.

The contraindication information generation section 112 compares the contraindication-related ingredient information received from the terminal 30 with the contraindication-related ingredient information corresponding to the drug/food purchased by the customer specified by the personal information received from the terminal 30 based on the purchase history information stored in the purchase history information table 174, and generates contraindication information that indicates contraindications to the drug/food combination, or precautions against the drug/food combination corresponding to the comparison result. The communication processing section 110 transmits the contraindication information generated by the contraindication information generation section 112 to the terminal 30.

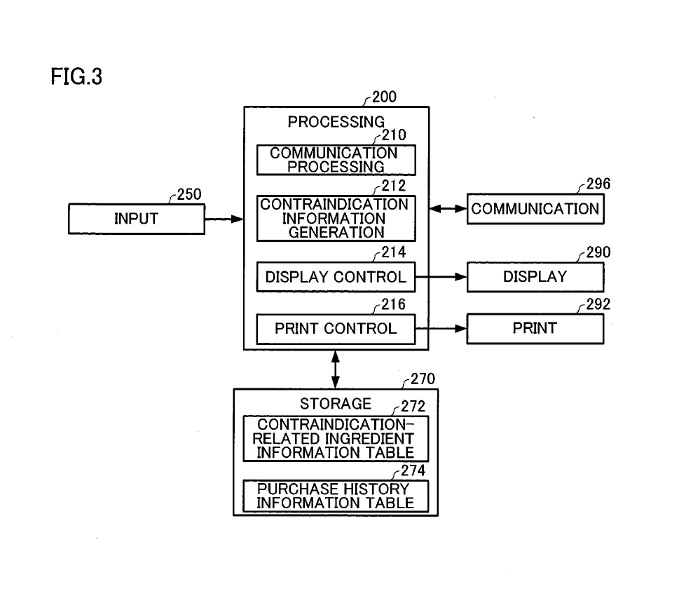

FIG. 3 illustrates an example of a functional block diagram of the store server 20. Note that the store server 20 may have a configuration in which some of the elements (sections) illustrated in FIG. 3 are omitted. The store server 20 includes a processing section 200, an input section 250, a storage section 270, a display section 290, a print section 292, and a communication section 296.

The input section 250 is a device that allows the user (e.g., store staff or pharmacist) to input information (i.e., detects the input information). The input section 250 outputs the information (operation input) input by the user to the processing section 200. The function of the input section 250 may be implemented by an input device such as a keyboard, a mouse, or a touch panel (touch panel display).

The storage section 270 (second server-side storage section) stores a program that causes a computer to function as each section of the processing section 200, and various types of data, and serves as a work area for the processing section 200. The function of the storage section 270 may be implemented by a hard disk, a RAM, or the like. The storage section 270 functions as a database that stores a contraindication-related ingredient information table 272 and a purchase history information table 274.

The contraindication-related ingredient information table 272 stores the contraindication-related ingredient information received from the central server 10. The purchase history information table 274 stores the purchase history information about the drug/food purchased by each customer in the store. The purchase history information table 274 also stores the personal information about each customer.

The display section 290 outputs an image generated by the processing section 200. The function of the display section 290 may be implemented by a display (e.g., LCD, CRT, or touch panel display).

The communication section 296 performs a control process for communicating with the central server 10 and the terminal 30. The function of the communication section 296 may be implemented by hardware such as a processor or a communication ASIC, a program, or the like.

The processing section 200 (processor) performs various processes based on a program, data received through the communication section 296, and the like. The function of the processing section 200 may be implemented by hardware such as a processor (e.g., CPU or DSP), or a program. The processing section 200 includes a communication processing section 210, a contraindication information generation section 212, a display control section 214, and a print control section 216.

The communication processing section 210 (second server-side communication processing section) performs a process that receives the contraindication-related ingredient information from the central server 10, and stores the received contraindication-related ingredient information in the contraindication-related ingredient information table 272, and a process that transmits the purchase history information (second purchase history information) about the drug/food purchased by each customer in the store, and the personal information about each customer to the central server 10. The communication processing section 210 may transmit the contraindication-related ingredient information (second contraindication-related ingredient information based on the purchase history information) about the contraindication-related ingredient included in the drug/food purchased by each customer in the store to the central server 10. The communication processing section 210 transmits the request information that requests the purchase history information about a customer to the central server 10 when selling a drug/food to the customer. The communication processing section 210 may receive the purchase history information (first purchase history information) transmitted from the central server 10 in response to the request information, and store the received purchase history information in the purchase history information table 274. The communication processing section 210 may transmit the request information that requests the contraindication-related ingredient information based on the purchase history information about a customer to the central server 10 when selling a drug/food to the customer.

The contraindication information generation section 212 compares the contraindication-related ingredient information corresponding to the drug/food that is sold to the customer with the contraindication-related ingredient information corresponding to the drug/food purchased by the customer in another store when selling a drug/food to the customer based on the contraindication-related ingredient information stored in the contraindication-related ingredient information table 272, and the purchase history information transmitted from the central server 10 in response to the request information (or the purchase history information stored in the purchase history information table 274), and generates the contraindication information that indicates contraindications to the drug/food combination, or precautions against the drug/food combination corresponding to the comparison result. The contraindication information generation section 212 may perform a comparison process based on the contraindication-related ingredient information stored in the contraindication-related ingredient information table 272 and the contraindication-related ingredient information (first contraindication-related ingredient information) transmitted from the central server 10 in response to the request information when selling a drug/food to the customer, and generate the contraindication information corresponding to the comparison result. The contraindication information generation section 212 may generate the contraindication information by performing image processing that synthesizes a plurality of pieces of contraindication-related ingredient information.

The contraindication information generation section 212 may compare the contraindication-related ingredient information corresponding to a drug/food that is sold to the customer with the personal information (e.g., age, sex, height, weight, previous disease, family history, drug being taken, and diathesis) about the customer, and generate the contraindication information corresponding to the comparison result.

The display control section 214 performs a control process that causes the display section 290 to display the contraindication information generated by the contraindication information generation section 212.

The print control section 216 performs a control process that causes the print section 292 to print the contraindication information generated by the contraindication information generation section 212. For example, when selling a drug, the contraindication information is printed on the packaging, sheet, or the like. When selling a food, the contraindication information is printed on the packaging or the like.

When the store server 20 is installed to provide an online shopping site, the store server 20 has a web server function. In this case, the terminal 30 accesses the online shopping URL of the store server 20, and transmits the user name and the password. When the user (customer) has been authenticated by the store server 20, the store server 20 transmits a web page for the user (i.e., a web page for the user to purchase a drug/food) to the terminal 30. The terminal 30 displays the received web page on the display section of the terminal 30. When the user has performed an operation that adds a drug/food to the shopping cart on the web page, article information that specifies the drug/food (article) added to the shopping cart is transmitted to the store server 20. The contraindication information generation section 212 acquires the contraindication-related ingredient information about the drug/food that is sold to the user based on the received article information and login information to generate the contraindication information, and the display control section 214 performs a control process that causes the generated contraindication information to be displayed on the web page for the user.

When the store server 20 is installed in an actual store, the contraindication information generation section 212 acquires the contraindication-related ingredient information about the drug/food that is sold to the user based on the article information and the customer information input from the input section 250 to generate the contraindication information. The display control section 214 performs a control process that causes the display section 290 to display the generated contraindication information, and the print control section 216 performs a control process that causes the generated contraindication information to be printed on the drug/food packaging or the like.

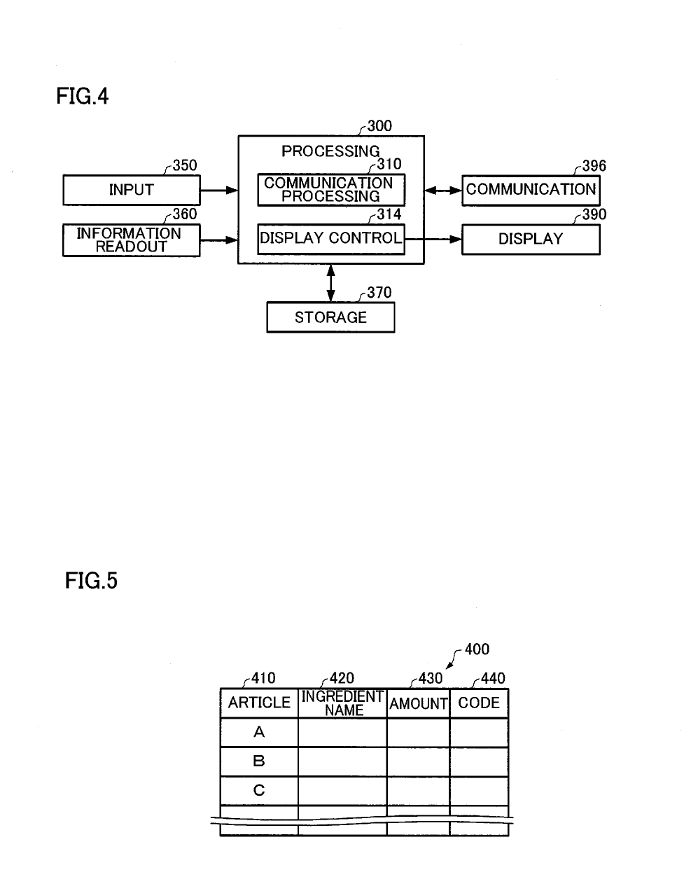

FIG. 4 illustrates an example of a block diagram of the terminal 30. Note that the terminal 30 may have a configuration in which some of the elements (sections) illustrated in FIG. 4 are omitted. The terminal 30 includes a processing section 300, an input section 350, an information readout section 360, a storage section 370, a display section 390, and a communication section 396.

The input section 350 is a device that allows the user (i.e., the user who possesses the terminal 30) to input information (i.e., detects the input information). The input section 350 outputs the information (operation input) input by the user to the processing section 300. The function of the input section 350 may be implemented by an input device such as a keyboard, a mouse, or a touch panel (touch panel display).

The information readout section 360 reads the contraindication-related ingredient information corresponding to the drug/food from the code provided to the drug/food (i.e., the contraindication information printed on the drug/food packaging or the like). The function of the information readout section 360 may be implemented by an image sensor (camera) or a scanner, a program, and a processor.

The storage section 370 stores a program that causes a computer to function as each section of the processing section 300, and various types of data, and serves as a work area for the processing section 300. The function of the storage section 370 may be implemented by a hard disk, a RAM, or the like.

The display section 390 outputs an image generated by the processing section 300. The function of the display section 390 may be implemented by a display (e.g., LCD, CRT, or touch panel display).

The communication section 396 performs a control process for communicating with the central server 10 and the store server 20. The function of the communication section 396 may be implemented by hardware such as a processor or a communication ASIC, a program, or the like.

The processing section 300 (processor) performs various processes based on a program, data received through the communication section 396, and the like. The function of the processing section 300 may be implemented by hardware such as a processor (e.g., CPU or DSP), or a program. The processing section 300 includes a communication processing section 310 and a display control section 314.

The communication processing section 310 (information processing terminal-side communication processing section) performs a process that transmits the contraindication-related ingredient information read by the information readout section 360 to the central server 10 together with the personal information, and a process that receives the contraindication information from the central server 10.

The display control section 314 performs a control process that causes the display section 390 to display the contraindication information received from the central server 10.

### 2. Method

A method according to one embodiment of the invention is described below with reference to the drawings.

FIG. 5 illustrates an example of the contraindication-related ingredient information table stored in the storage section included in the central server 10 and the storage section included in the store server 20.

As illustrated in FIG. 5, a contraindication-related ingredient information table 400 stores an article 410 (article ID) (i.e., drug or food) that is on sale in each store in which the store server 20 is installed, an ingredient name 420 that indicates the name of the contraindication-related ingredient (or an ingredient that may be a contraindication-related ingredient) included in each article, an amount 430 that indicates the amount of contraindication-related ingredient (or an ingredient that may be a contraindication-related ingredient) included in each article, and code information 440 (contraindication-related ingredient information) that indicates the contraindication-related ingredient and the amount thereof. Note that the contraindication-related ingredient information table 400 may store only the article 410, the ingredient name 420, and the amount 430, or may store only the article 410 and the code information 440. The term “contraindication-related ingredient” used herein refers to an ingredient that is included in a drug, and is likely to worsen a condition, cause a side effect, or weaken the effect of the drug, when the drug is taken alone or in combination with another drug (or food), for example. In one embodiment of the invention, the term “contraindication-related ingredient” used herein also includes an ingredient (allergen) that is included in a food, and is likely to cause a severe allergic symptom (particularly anaphylactic shock) depending on the diathesis when the food is taken.

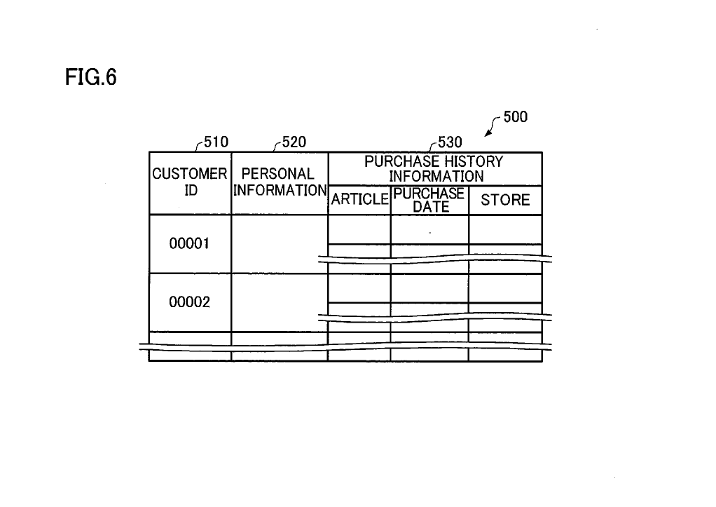

FIG. 6 illustrates an example of the purchase history information table stored in the storage section included in the central server 10.

As illustrated in FIG. 6, the purchase history information table 500 stores identification information 510 (customer ID), personal information 520, and purchase history information 530 about each customer. The personal information 520 includes information (e.g., age, sex, height, weight, address, previous disease, family history, drug being taken, and diathesis (allergic predisposition)) about each customer, and the purchase history information 530 includes the article ID that indicates the article (i.e., drug or food) purchased by each customer, the purchase date information, and the store ID that indicates the store in which the article was purchased.

The purchase history information table stored in the storage section included in the store server 20 also stores the personal information and the purchase history information. Note that the purchase history information stored in the purchase history information table stored in the storage section included in the store server 20 includes only the purchase history information about the drug/food purchased by each customer in the store in which the store server 20 is installed. The central server 10 receives the purchase history information from the store server 20 installed in each store, and stores the received purchase history information in the purchase history information table 500. Therefore, the purchase history information table 500 stored in the storage section included in the central server 10 stores the purchase history information about the drug/food purchased by each customer in each store in which the store server 20 is installed.

The contraindication information generation section 212 included in the store server 20 acquires the contraindication-related ingredient information corresponding to the article (i.e., drug or food) that is sold to the customer based on the input or received article information referring to the contraindication-related ingredient information table 400. When selling a plurality of articles to the customer, the contraindication information generation section 212 acquires a plurality of pieces of contraindication-related ingredient information respectively corresponding to the plurality of articles. The contraindication information generation section 212 transmits the request information that requests the purchase history information about the customer (or the contraindication-related ingredient information based on the purchase history information about the customer) to the central server 10 based on the input or received customer information.

The central server 10 transmits the purchase history information about the drug/food purchased by the customer in a store other than the store in which the store server 20 (i.e., the store server 20 that has transmitted the request information) is installed (or the contraindication-related ingredient information acquired based on the purchase history information referring to the contraindication-related ingredient information table 400) to the store server 20 based on the request information received from the store server 20 referring to the purchase history information table 500. For example, when the store server 20 installed in a store A has transmitted the request information that requests the purchase history information about a customer having a customer ID of 0001, the central server 10 transmits the purchase history information about the drug/food purchased by the customer in a store (e.g., store B) other than the store A (or the contraindication-related ingredient information based on the purchase history information) to the store server 20 installed in the store A. Note that the central server 10 may transmit only the purchase history information during a predetermined period from the reception date of the request information to the store server 20. The central server 10 may transmit the purchase history information about the customer designated by the request information, and the purchase history information about the family of the designated customer to the store server 20. This is because the family of the designated customer may purchase a drug/food on behalf of the designated customer. In this case, a customer having the same address as that of the designated customer may be considered to be the family of the designated customer.

The store server 20 acquires the contraindication-related ingredient information corresponding to the article included in the purchase history information based on the purchase history information received from the central server 10 referring to the contraindication-related ingredient information table 400. The contraindication information generation section 212 included in the store server 20 compares a plurality of pieces of contraindication-related ingredient information thus acquired to generate the contraindication information.

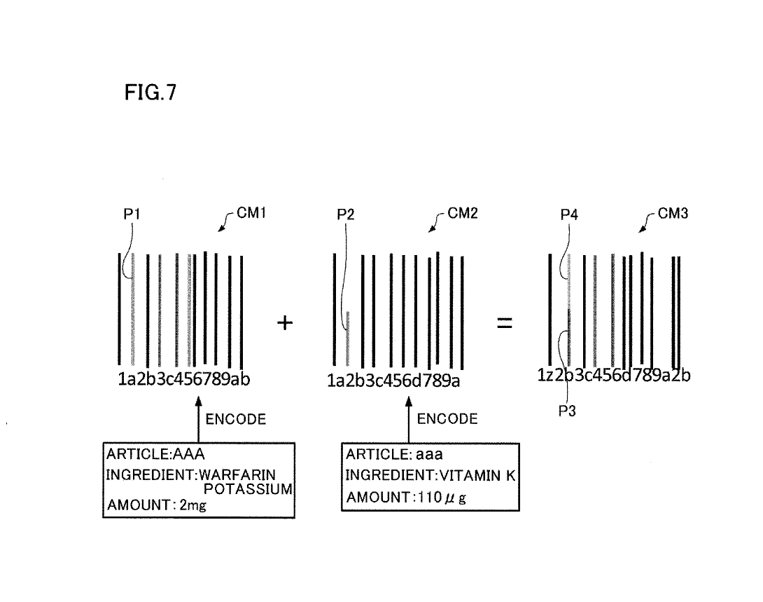

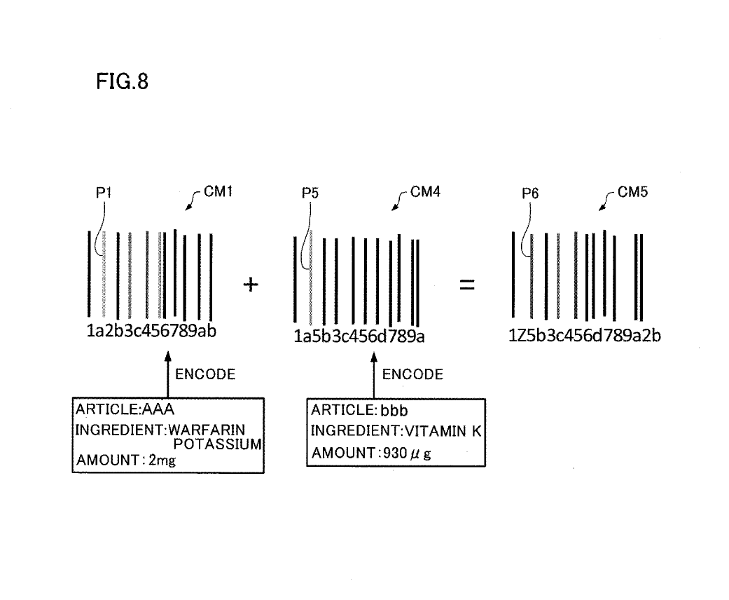

FIGS. 7 and 8 illustrate a contraindication information generation process. FIG. 7 illustrates an example in which contraindication-related ingredient information CM1 about a drug “AAA” is compared with contraindication-related ingredient information CM2 about a food “aaa” to generate contraindication information CM3. The name, the ingredient, the effect, and the like of the drug may be displayed as the contraindication-related ingredient information. Note that it is preferable to encode or encrypt the contraindication-related ingredient information from the viewpoint of protecting personal information.

The contraindication-related ingredient information may be image information that includes pattern information and color information generated by encoding the name of the article, the type of ingredient (contraindication-related ingredient), and the amount of ingredient. For example, when the drug “AAA” is an antithrombogenic drug that includes warfarin potassium, and the food “aaa” includes vitamin K, the effect of the drug “AAA” decreases when the drug “AAA” is taken in combination with the food “aaa”. In the contraindication-related ingredient information CM1, the pattern (position, shape, and color) indicated by P1 represents the type (warfarin potassium) and the amount of contraindication-related ingredient. In the contraindication-related ingredient information CM2, the pattern indicated by P2 represents the type (vitamin K) and the amount of contraindication-related ingredient. In the contraindication-related ingredient information CM2, the color of the pattern indicated by P2 represents the type of contraindication-related ingredient, and the length (shape) of the pattern indicated by P2 represents the amount of contraindication-related ingredient.

As illustrated in FIG. 7, the contraindication information CM3 is generated by performing image processing that synthesizes the contraindication-related ingredient information CM1 and the contraindication-related ingredient information CM2. The contraindication information CM3 includes pattern information that indicates the types and the amounts of ingredients included in the articles (“AAA” and “aaa”), and color information that indicates contraindications to the combined intake of the articles or precautions against the combined intake of the articles. For example, 216 web safe colors with good color reproducibility may be used for the color information.

In the contraindication information CM3, the color of the pattern indicated by P3 is red, and indicates the presence of the contraindication-related ingredient. The color of the pattern indicated by P4 is yellow, and indicates the presence of the effect of a drug (i.e., the effect of warfarin potassium). Specifically, the contraindication information CM3 indicates that the contraindication-related ingredient is included within the allowable range, and indicates precautions against the combined intake of the articles.

The contraindication information thus generated is displayed on a display (display section 290) installed in the store or the display section (display section 390) of the terminal, or printed on the drug/food packaging or the like in color. This makes it possible for the user (customer) to check the contraindication information when purchasing the article. When contraindication information that indicates precautions against the combined intake of articles has been generated (e.g., the contraindication information CM3 illustrated in FIG. 7), information that indicates to that effect (e.g., information that advises the customer to reduce intake of food including vitamin K, and presents other foods including vitamin K) may be displayed on the display section together with the contraindication information. The customer information may be exposed to store staff or other customers when the name of the drug is displayed, or the name of the customer is printed. According to one embodiment of the invention, however, since the name of the article is represented by the identification code, and the amount of ingredient is represented by the color code, it is possible to protect the privacy of personal information. Note that the name of the customer may also be encoded, for example. Since the contraindication-related ingredient information (contraindication information) is generated (encoded) based on the type and the amount of ingredient included in a drug/food, it is possible to appropriately manage the contraindication information even when the customer purchases an article having a different name, or including a different amount of ingredient.

FIG. 8 illustrates an example in which contraindicated ingredient information CM1 about a drug “AAA” is compared with contraindicated ingredient information CM4 about a food “bbb” to generate contraindication information CM5. The food “bbb” includes vitamin K as the contraindication-related ingredient. In the contraindication-related ingredient information CM4, the pattern indicated by P5 represents the type and the amount of contraindication-related ingredient (vitamin K). Since the amount of vitamin K is larger than that of the food “aaa”, the pattern indicated by P5 is longer than the pattern of the contraindication-related ingredient information CM2 indicated by P2. In the contraindication information CM5 generated by synthesizing the contraindication-related ingredient information CM1 and the contraindication-related ingredient information CM4, the color of the pattern indicated by P6 is red, and indicates the presence of the contraindication-related ingredient, and the absence of the effect of the drug. Specifically, the contraindication information CM5 indicates that the contraindication-related ingredient is included in an amount exceeding the allowable range, and indicates contraindications to the combined intake of the articles.

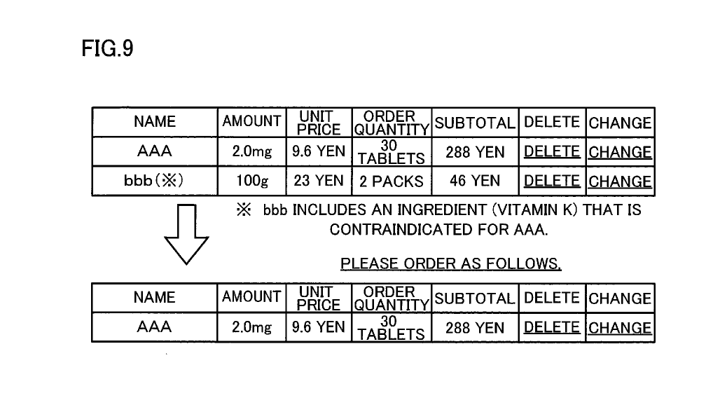

When the store server 20 has generated the contraindication information that indicates contraindications to the combined intake of the articles, information that indicates to the effect is displayed on the display section, and a process is performed so that the articles are not sold to the customer at the same time. Specifically, when the customer desires to purchase the drug “AAA” and the food “bbb” at the same time (see FIG. 8), a process is performed based on the contraindication information so that only the drug “AAA” is sold to the customer. For example, when the customer has performed an operation that adds the drug “AAA” and the food “bbb” to the shopping cart on an online shopping site (see FIG. 9), information that indicates that the combined intake of the drug “AAA” and the food “bbb” is contraindicated is displayed on the web page, and one of the drug “AAA” and the food “bbb” (e.g., food “bbb”) is deleted from the shopping cart (or information that prompts the customer to delete one of the drug “AAA” and the food “bbb” is displayed). When an alternative to the articles is present, information that presents the alternative may be displayed. When the customer knows that the combined intake of the articles is contraindicated, and does not desire that information that indicates to that effect be displayed/output, the information need not necessarily be displayed/output, but is recorded/stored in the central server 10 and the store server 20.

Since the sales management support system according to one embodiment of the invention is configured so that the central server 10 centrally manages the purchase history information corresponding to a plurality of stores in which the store server 20 is installed, and the contraindication-related ingredient information about the article (drug or food) that is sold to a customer in one store is compared with the contraindication-related ingredient information about the article purchased by the customer (or the family of the customer) in another store to generate the contraindication information, it is possible to appropriately present the contraindication information even when the customer (user) purchases a drug/food in a plurality of stores (particularly a plurality of stores that differ in store form or sales form). Since the contraindication information is generated so that contraindications to (or precautions against) the combined intake are represented by the color information, the user can easily visually determine contraindications (or precautions) even when the user is not a recipient, and does not have knowledge of the contraindication information.

The sales management support system according to one embodiment of the invention may compare the contraindication-related ingredient information about the article that is sold to the customer with the personal information (e.g., previous disease, family history, drug being taken, and diathesis) about the customer to generate the contraindication information. For example, information about a disease (e.g., primary disease, complication, previous history, and family history) or diathesis for which the use of each article (drug/food) is contraindicated (or relatively contraindicated) may be incorporated in the contraindication-related ingredient information about each article (drug/food). When it has been determined by the comparison between the contraindication-related ingredient information and the personal information that the customer who desires to purchase an article suffers from such a disease or diathesis, a process may be performed that prevents the article from being sold to the customer. When it has been determined that the customer who desires to purchase an article suffers from a disease or diathesis for which the use of the article is contraindicated relatively, a process may be performed so that the article is sold to the customer on condition that the use of the article has been approved by a physician, or a physician has written a prescription for the use of the article.

When it has been determined that the article that is sold to the customer does not include a contraindication-related ingredient based on the article information or the customer information input to the store server 20, or when it has been determined that the customer does not suffer from a disease or diathesis for which the use of the article is contraindicated, the store server 20 may not access the central server 10 (i.e. the store server 20 may not transmit the request information to the central server 10). This makes it possible to implement a prompt sales process when there are no contraindication issues. When the purchase history information corresponding to another store (or the contraindication-related ingredient information based on the purchase history information) is stored in the storage section included in the store server 20, the store server 20 may generate the contraindication information without transmitting the request information to the central server 10. The customer information (e.g., the symptom (fever, cough, or headache) or the state of the patient (e.g., baby or pregnant woman)) may be input to the store server 20 at the time of purchase, for example.

The sales management support system according to one embodiment of the invention also allows the user to check the contraindication information about the purchased drug/food when taking the purchased drug/food.

Specifically, the user can read the code (printed contraindication information) provided to the packaging of the purchased drug/food using a camera of the terminal 30, or a scanner connected to the terminal 30, and the contraindication-related ingredient information and the customer ID read from the code are transmitted to the central server 10. The central server 10 compares the contraindication-related ingredient information received from the terminal 30 with the contraindication-related ingredient information about the article previously purchased by the user (or the personal information (e.g., previous disease) about the user) based on the customer ID received from the terminal 30 by referring to the purchase history information to generate the contraindication information. The generated contraindication information is transmitted to the terminal 30, and displayed on the display section of the terminal 30.

### 3. Process

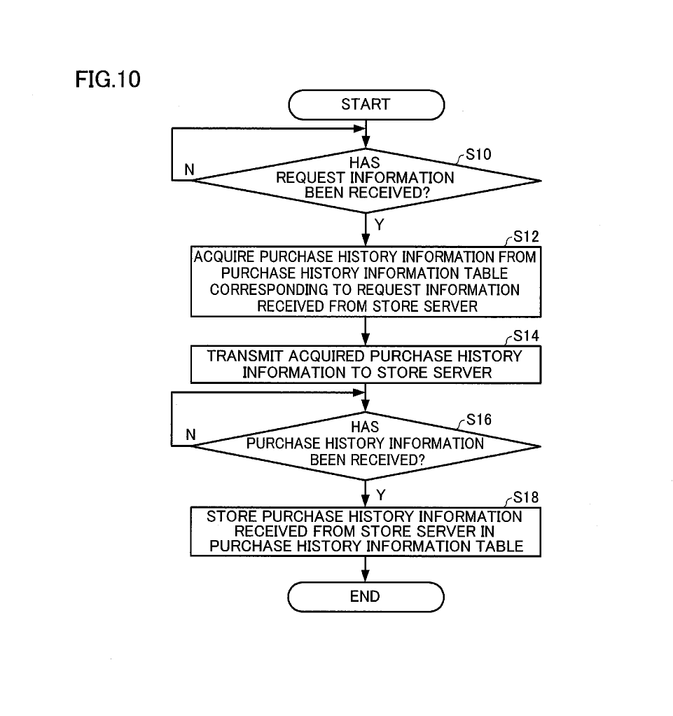

An example of the process performed by the sales management support system according to one embodiment of the invention is described below with reference to FIGS. 10 to 12.

FIG. 10 is a flowchart illustrating the flow of the process performed by the central server 10.

The communication processing section 110 determines whether or not the request information has been received from the store server 20 (step S10). When the communication processing section 110 has determined that the request information has been received from the store server 20 (Y in step S10), the communication processing section 110 acquires the purchase history information from the purchase history information table 174 corresponding to the received request information (step S12). Specifically, the communication processing section 110 acquires the article ID corresponding to a store ID of a store other than the store specified by the store ID included in the received request information based on the store ID and the customer ID included in the received request information by referring to the purchase history information table 174. The communication processing section 110 may acquire the personal information corresponding to the customer ID together with the article ID.

The communication processing section 110 transmits the acquired purchase history information (article ID and personal information) to the store server 20 (i.e., the store server 20 that has transmitted the request information) (step S14). The communication processing section 210 may transmit the contraindication-related ingredient information based on the acquired purchase history information (i.e., the code information 440 corresponding to the acquired article ID) instead of the acquired purchase history information.

The communication processing section 110 determines whether or not the purchase history information has been received from the store server 20 (step S16). When the communication processing section 110 has determined that the purchase history information has been received from the store server 20 (Y in step S16), the communication processing section 110 stores the received purchase history information in the purchase history information table 174 (step S18). Specifically, the communication processing section 110 stores the article ID, the purchase date information, and the store ID included in the received purchase history information in the purchase history information table 174 corresponding to the customer ID included in the received purchase history information. When the personal information about the customer has been received from the store server 20, the communication processing section 110 stores the received personal information in the purchase history information table 174 corresponding to the customer ID included in the received personal information.

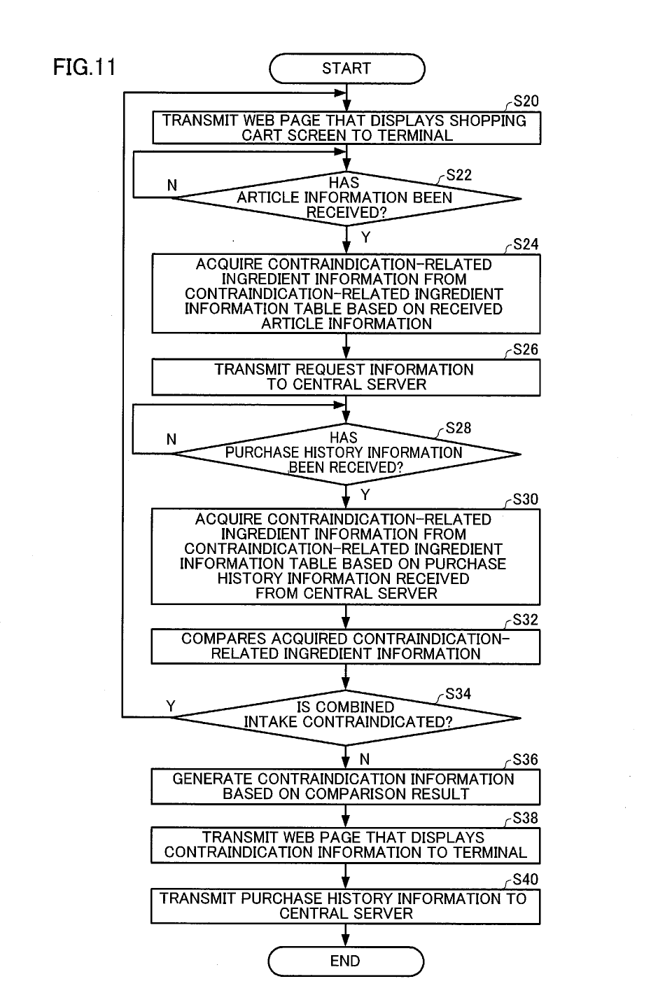

FIG. 11 is a flowchart illustrating the flow of the process performed by the store server 20 installed to provide an online shopping site.

The communication processing section 210 transmits a web page that displays a shopping cart screen to the terminal of the user (customer) who has logged into the online shopping site (step S20).

The communication processing section 210 determines whether or not article information (i.e., information that indicates the article that has been added to the shopping cart by the user) has been received from the terminal of the user (step S22). When the communication processing section 210 has determined that the article information has been received from the terminal of the user (Y in step S22), the contraindication information generation section 212 acquires the contraindication-related ingredient information from the contraindication-related ingredient information table 272 based on the received article information (step S24). Specifically, the contraindication information generation section 212 refers to the contraindication-related ingredient information table 272 based on the article ID included in the received article information, and acquires the contraindication-related ingredient information (code information 440) corresponding to the article ID. When a plurality of article ID are included in the received article information (i.e., when a plurality of articles have been added to the shopping cart), the contraindication information generation section 212 acquires a plurality of pieces of contraindication-related ingredient information respectively corresponding to the plurality of article ID.

The communication processing section 210 transmits the request information to the central server 10 (step S26). The request information includes the customer ID specified by login information about the user, and the store ID that specifies the store in which the store server 20 is installed.

The communication processing section 210 determines whether or not the purchase history information has been received from the central server 10 (step S28). When the communication processing section 210 has determined that the purchase history information has been received from the central server 10 (Y in step S28), the contraindication information generation section 212 acquires the contraindication-related ingredient information from the contraindication-related ingredient information table 272 based on the received purchase history information (step S30). Specifically, the contraindication information generation section 212 refers to the contraindication-related ingredient information table 272 based on the article ID included in the received purchase history information, and acquires the contraindication-related ingredient information (code information 440) corresponding to the article ID. In the step S30, the contraindication information generation section 212 may acquire the contraindication-related ingredient information (contraindication-related ingredient information based on the purchase history information) transmitted from the central server 10 in response to the request information. When the personal information is stored in the purchase history information table 274, the contraindication information generation section 212 may acquire the personal information corresponding to the customer ID specified by the login information about the user. When the personal information is not stored in the purchase history information table 274, the contraindication information generation section 212 may acquire the personal information included in the purchase history information received from the central server 10.

The contraindication information generation section 212 compares the contraindication-related ingredient information acquired in the step S24 with the contraindication-related ingredient information acquired in the step S30 (step S32). When the comparison result indicates that the combined intake of the articles is contraindicated (Y in step S34), the contraindication information generation section 212 displays information that indicates that the combined intake of the articles is contraindicated on the web page, and deletes one of the articles.

When the comparison result indicates that the combined intake of the articles is not contraindicated (N in step S34), the contraindication information generation section 212 generates the contraindication information based on the comparison result (step S36). For example, the contraindication information generation section 212 generates the contraindication information by performing image processing that synthesizes the acquired contraindication-related ingredient information. Note that the acquired contraindication-related ingredient information may be compared with the personal information (e.g., previous disease, family history, drug being taken, and diathesis) in the step S32. The step S20 may be performed when the comparison result indicates that the combined intake of the articles is contraindicated, and the step S36 may be performed when the comparison result indicates that the combined intake of the articles is not contraindicated (or is contraindicated relatively).

The communication processing section 210 transmits a web page that displays the generated contraindication information to the terminal of the user (step S38). The communication processing section 210 stores the article ID of the article purchased by the user and the purchase date information in the purchase history information table 174 corresponding to the customer ID of the user, and transmits the purchase history information that includes the customer ID, the article ID, the purchase date information, and the store ID to the central server 10 (step S40).

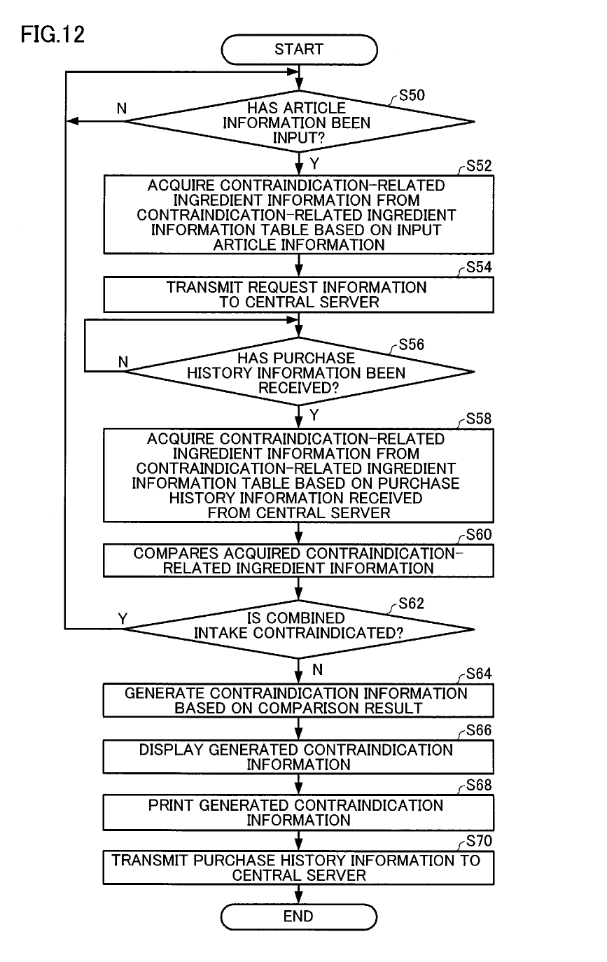

FIG. 12 is a flowchart illustrating the flow of the process performed by the store server 20 installed in an actual store.

The contraindication information generation section 212 determines whether or not the article information (e.g., drug information) and the customer information (e.g., insurance number, store membership number, card number, credit card number, and portable terminal number) have been input from the input section 250 (step S50). When the contraindication information generation section 212 has determined that the article information and the customer information have been input from the input section 250 (Y in step S50), the contraindication information generation section 212 acquires the contraindication-related ingredient information from the contraindication-related ingredient information table 272 based on the input article information (step S52). Specifically, the contraindication information generation section 212 refers to the contraindication-related ingredient information table 272 based on the article ID included in the input article information, and acquires the contraindication-related ingredient information (code information 440) corresponding to the article ID. When a plurality of article ID are included in the input article information (i.e., when a plurality of articles are to be sold), the contraindication information generation section 212 acquires a plurality of pieces of contraindication-related ingredient information respectively corresponding to the plurality of article ID.

The communication processing section 210 transmits the request information to the central server 10 (step S54). The request information includes the customer ID specified by the input customer information, and the store ID that specifies the store in which the store server 20 is installed.

The communication processing section 210 determines whether or not the purchase history information has been received from the central server 10 (step S56). When the communication processing section 210 has determined that the purchase history information has been received from the central server 10 (Y in step S56), the contraindication information generation section 212 acquires the contraindication-related ingredient information from the contraindication-related ingredient information table 272 based on the received purchase history information (step S58). Specifically, the contraindication information generation section 212 refers to the contraindication-related ingredient information table 272 based on the article ID included in the received purchase history information, and acquires the contraindication-related ingredient information (code information 440) corresponding to the article ID. In the step S58, the contraindication information generation section 212 may acquire the contraindication-related ingredient information (contraindication-related ingredient information based on the purchase history information) transmitted from the central server 10 in response to the request information. When the personal information is stored in the purchase history information table 274, the contraindication information generation section 212 may acquire the personal information corresponding to the customer ID specified by the input customer information. When the personal information is not stored in the purchase history information table 274, the contraindication information generation section 212 may acquire the personal information included in the purchase history information received from the central server 10.

The contraindication information generation section 212 compares the contraindication-related ingredient information acquired in the step S52 with the contraindication-related ingredient information acquired in the step S58 (step S60). When the comparison result indicates that the combined intake of the articles is contraindicated (Y in step S62), the display control section 214 performs the control process that causes the display section 290 to display information that indicates that the combined intake of the articles is contraindicated. The display control section 214 may perform a control process that causes the display section 290 to display a screen in which a red lamp is turned on in order to alert the store staff/pharmacist.

When the comparison result indicates that the combined intake of the articles is not contraindicated (N in step S62), the contraindication information generation section 212 generates the contraindication information based on the comparison result (step S64). For example, the contraindication information generation section 212 generates the contraindication information by performing image processing that synthesizes the acquired contraindication-related ingredient information. Note that the acquired contraindication-related ingredient information may be compared with the personal information (e.g., previous disease, family history, drug being taken, and diathesis) in the step S64. The step S50 may be performed when the comparison result indicates that the combined intake of the articles is contraindicated, and the step S64 may be performed when the comparison result indicates that the combined intake of the articles is not contraindicated (or is contraindicated relatively).

The display control section 214 performs the control process that causes the display section 290 to display the generated contraindication information (step S66), and the print control section 216 performs the control process that outputs the generated contraindication information to the print section 292, and causes the print section 292 to print the contraindication information (step S68). The communication processing section 210 stores the article ID of the article purchased by the user and the purchase date information in the purchase history information table 174 corresponding to the customer ID of the user, and transmits the purchase history information that includes the customer ID, the article ID, the purchase date information, and the store ID to the central server 10 (step S70).

### 4. Modifications

The invention is not limited to the above embodiments. Various modifications and variations may be made of the above embodiments. For example, the invention includes various other configurations that are substantially the same as the configurations described in connection with the above embodiments (e.g., a configuration having the same function, method, and results, or a configuration having the same objective and results). The invention also includes a configuration in which an unsubstantial section (element) described in connection with the above embodiments is replaced with another section (element). The invention also includes a configuration having the same effects as those of the configurations described in connection with the above embodiments, or a configuration capable of achieving the same objective as that of the configurations described in connection with the above embodiments. The invention further includes a configuration in which a known technique is added to the configurations described in connection with the above embodiments.

Although the above embodiments have been described taking an example in which the central server 10 communicates directly with the store servers 20, a management server that manages the store servers 20 that are respectively installed in a plurality of stores that are identical as to the sales form (i.e., a plurality of stores that belong to an identical retail group) may be provided, and the management server may relay communication between the central server 10 and the store servers 20 (i.e., the central server 10 may communicate with the store servers 20 through the management server).

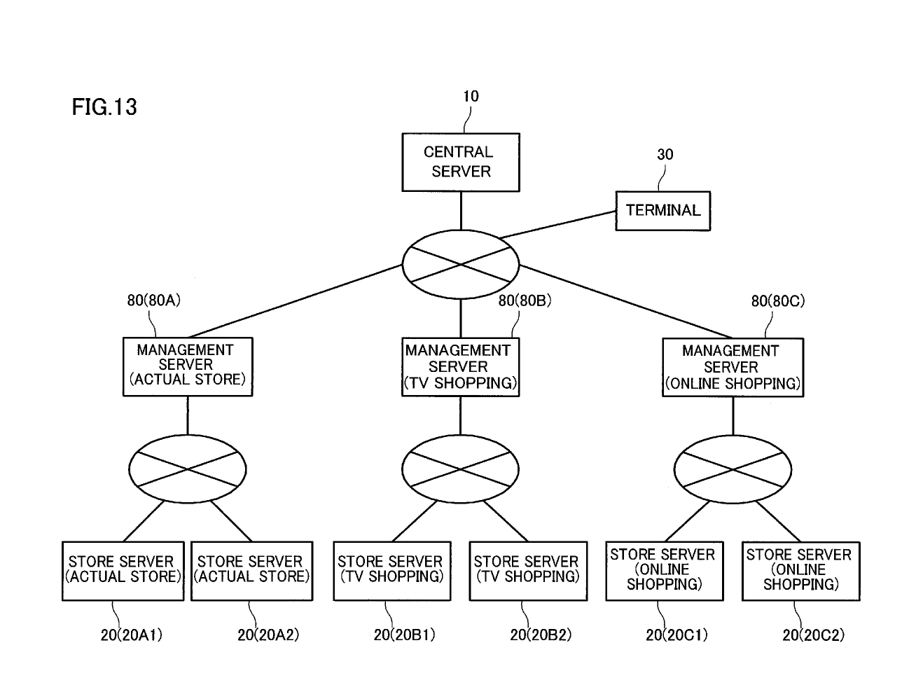

FIG. 13 is a diagram illustrating an example of the sales management system that includes the management server. As illustrated in FIG. 13, a management server 80 (third server) is connected to the central server 10 and the store servers 20 through a network. In the example illustrated in FIG. 13, a management server 80A relays communication between the central server 10 and store servers 20A1 and 20A2 that are respectively installed in actual stores, a management server 80B relays communication between the central server 10 and store servers 20B1 and 20B2 that are respectively installed in TV shopping business offices, and a management server 80C relays communication between the central server 10 and store servers 20C1 and 20C2 that are respectively installed to provide an online shopping site. Each management server 80 transmits the request information and the purchase history information transmitted from each store server 20 to the central server 10, and transmits the purchase history information and the contraindication-related ingredient information transmitted from the central server 10 to each store server 20. When the information format (e.g., of request information, purchase history information, and contraindication-related ingredient information) differs between a plurality of groups due to a difference in the system, each management server 80 may be configured to absorb the difference in format. For example, each management server 80 may convert the request information and the purchase history information in original format transmitted from the store server 20 into the request information and the purchase history information in common format, and transmit the request information and the purchase history information in common format to the central server 10. Each management server 80 may convert the purchase history information and the contraindication-related ingredient information in common format into the purchase history information and the contraindication-related ingredient information in original format, and transmit the purchase history information and the contraindication-related ingredient information in original format to the store server 20.

Although only some embodiments of the invention have been described in detail above, those skilled in the art would readily appreciate that many modifications are possible in the embodiments without materially departing from the novel teachings and advantages of the invention. Accordingly, all such modifications are intended to be included within the scope of the invention.

What is claimed is:

1. A sales management support system that supports drug/food sales management, and comprises a first server, and a second server that is connected to the first server through a network, and installed in a store,
the first server including:
a first server-side storage section that stores a contraindication-related ingredient information table and a purchase history information table, the contraindication-related ingredient information table storing contraindication-related ingredient information about a contraindication-related ingredient included in a drug/food that is on sale in the store, and the purchase history information table storing purchase history information about a drug/food that was purchased by a customer; and
a first server-side communication processing section that performs a process that transmits first contraindication-related ingredient information stored in the contraindication-related ingredient information table or first purchase history information stored in the purchase history information table to the second server, and a process that receives second purchase history information about a drug/food that was purchased by the customer in the store, or second contraindication-related ingredient information based on the purchase history information from the second server, and stores the received second purchase history information or the received second contraindication-related ingredient information in the purchase history information table or the contraindication-related ingredient information table,
the first server-side communication processing section performing a process that transmits the first purchase history information or the first contraindication-related ingredient information to the second server in response to request information received from the second server, and
the second server including a contraindication information generation section that generates contraindication information based on the first purchase history information or the first contraindication-related ingredient information transmitted from the first server when selling a drug/food to the customer, the contraindication information indicating contraindications to intake of a drug/food combination, or precautions against intake of the drug/food combination.

2. The sales management support system as defined in claim 1,
the first contraindication-related ingredient information or the first purchase history information including the purchase history information or the contraindication-related ingredient information about a drug/food that was purchased by the customer in a store other than the store in which the second server is installed.

3. The sales management support system as defined in claim 1,
the second server further including a second server-side storage section that stores the first contraindication-related ingredient information or the first purchase history information received from the first server.

4. The sales management support system as defined in claim 2,
the second server further including a second server-side storage section that stores the first contraindication-related ingredient information or the first purchase history information received from the first server.

5. The sales management support system as defined in claim 1,
the contraindication information generation section comparing the first contraindication-related ingredient information corresponding to a drug/food that is sold to the customer with the contraindication-related ingredient information corresponding to a drug/food that was purchased by the customer in another store, and generating the contraindication information corresponding to a comparison result.

6. The sales management support system as defined in claim 2,
the contraindication information generation section comparing the first contraindication-related ingredient information corresponding to a drug/food that is sold to the customer with the contraindication-related ingredient information corresponding to a drug/food that was purchased by the customer in another store, and generating the contraindication information corresponding to a comparison result.

7. The sales management support system as defined in claim 3,
the contraindication information generation section comparing the first contraindication-related ingredient information corresponding to a drug/food that is sold to the customer with the contraindication-related ingredient information corresponding to a drug/food that was purchased by the customer in another store, and generating the contraindication information corresponding to a comparison result.

8. The sales management support system as defined in claim 4,
the contraindication information generation section comparing the first contraindication-related ingredient information corresponding to a drug/food that is sold to the customer with the contraindication-related ingredient information corresponding to a drug/food that was purchased by the customer in another store, and generating the contraindication information corresponding to a comparison result.

9. The sales management support system as defined in claim 1,
the first server-side communication processing section not transmitting the first purchase history information to the second server in response to the request information received from the second server when the first contraindication-related ingredient information does not fall under the request information.

10. The sales management support system as defined in claim 3,
the contraindication information generation section performing a comparison process on the contraindication-related ingredient information corresponding to a drug/food that is sold to the customer based on the first contraindication-related ingredient information or the first purchase history information stored in the second server-side storage section, and generating the contraindication information.

11. The sales management support system as defined in claim 4,
the contraindication information generation section performing a comparison process on the contraindication-related ingredient information corresponding to a drug/food that is sold to the customer based on the first contraindication-related ingredient information or the first purchase history information stored in the second server-side storage section, and generating the contraindication information.

12. The sales management support system as defined in claim 1,
the first server being connected to a plurality of the second servers respectively installed in a plurality of stores through an identical network or different networks.

13. The sales management support system as defined in claim 1,
the first server comparing the first contraindication-related ingredient information with the second contraindication-related ingredient information, or comparing the first purchase history information with the second purchase history information, and updating the contraindication-related ingredient information table and the purchase history information table.

14. The sales management support system as defined in claim 1,
the contraindication-related ingredient information being image information that includes pattern information that indicates a type and/or an amount of contraindication-related ingredient included in a drug/food that is on sale, and color information that indicates contraindications to, or precautions against, combined intake.

15. The sales management support system as defined in claim 2,
the contraindication-related ingredient information being image information that includes pattern information that indicates a type and/or an amount of contraindication-related ingredient included in a drug/food that is on sale, and color information that indicates contraindications to, or precautions against, combined intake.

16. The sales management support system as defined in claim 14,
the contraindication information generation section generating the contraindication information by performing image processing that synthesizes a plurality of pieces of the contraindication-related ingredient information.

17. The sales management support system as defined in claim 15,
the contraindication information generation section generating the contraindication information by performing image processing that synthesizes a plurality of pieces of the contraindication-related ingredient information.

18. The sales management support system as defined in claim 1,
the second server further including a display control section that performs a control process that causes a display section to display the contraindication information.

19. The sales management support system as defined in claim 1,
the second server further including a print control section that performs a control process that causes a print section to print the contraindication information.

20. The sales management support system as defined in claim 1, further comprising:
an information processing terminal that is connected to the first server through a network,
the information processing terminal including:
an information readout section that reads the contraindication-related ingredient information corresponding to a drug/food from a code provided to the drug/food; and
an information processing terminal-side communication processing section that performs a process that transmits the contraindication-related ingredient information read by the information readout section to the first server together with personal information,
the first server further including a contraindication information generation section that compares the contraindication-related ingredient information received from the information processing terminal with the contraindication-related ingredient information corresponding to a drug/food that was purchased by a customer specified by the personal information received from the information processing terminal, and generates the contraindication information corresponding to a comparison result, the contraindication information indicating contraindications to intake of a drug/food combination, or precautions against intake of the drug/food combination, and
the first server-side communication processing section transmitting the generated contraindication information to the information processing terminal
